(19) United States
(12) Patent Application Publication
(10) Pub. No.: US 2022/0172325 A1
(43) Pub. Date: Jun. 2, 2022

(54) COMPUTATIONAL OBJECT STORAGE FOR OFFLOAD OF DATA AUGMENTATION AND PREPROCESSING

(71) Applicant: Intel Corporation, Santa Clara, CA (US)

(72) Inventor: Ananda C. S. MAHESH, Austin, TX (US)

(21) Appl. No.: 17/673,689

(22) Filed: Feb. 16, 2022

(51) Int. Cl. G06T 3/40; G06T 11/60; G06T 11/40; G06K 9/62

(52) U.S. Cl. CPC G06T 3/4046; G06K 9/6257; G06T 11/40; G06T 11/60

(57) ABSTRACT

A system that executes a distributed application, such as a machine learning model, can have a processor node among a system of nodes to generate a request for data and a storage node among a system of nodes that stores the requested data. The processor node will use the data for iterative processing to train a machine learning model. The storage node receives the request for the data, reads the data, preprocess the data to perform requested data transformation on the data on demand, and provides the preprocessed data to the processor node for the iterative processing. The processor node can request storage system nodes to store data in a manner suitable for preprocessing. In response to receiving a request, the storage node can interpret hints or metadata associated with the storage operation and perform the requested data store operation.

### FIELD

Descriptions are generally related to machine learning, and more particular descriptions are related to data preprocessing for machine learning.

### BACKGROUND

Machine learning and deep learning require significant amounts of data to train the model or models used in pattern recognition. Machine learning is typically performed in a server environment with training server nodes having one or more central processing units (CPUs) that perform iterative processing, which may include offloading processing tasks to a graphics processing unit (GPU) or other accelerator.

The amount of data needed to perform the training cannot realistically all be stored at the processor node where the processing occurs. Data is moved over a communication fabric between an external storage system having one or more storage nodes and the processor nodes that perform the iterative processing.

Effective machine learning involves data preprocessing and data augmentation to diversify and randomize the input data. The data may also need preprocessing operations to clean up the data for use in the training model.

Traditionally, preprocessing can be offloaded to a dedicated data preprocessing accelerator on the training server node, which increases the cost to put a dedicated preprocessing processor on the server node. Preprocessing can also be offloaded the GPU, which requires the GPU to support the preprocessing capabilities, and which also “steals” processing cycles from the GPU by using processing bandwidth of the GPU that will then be unavailable for processing.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 is a block diagram of an example of a system with preprocessing resources in a storage node.

FIG. 2 is a block diagram of an example of a system with a software framework to support storage node preprocessing offloading.

FIG. 3 is a block diagram of an example of a storage device with multiple storage nodes to implement preprocessing offloading.

FIG. 4 is a flow diagram of an example of a process for storing training data for subsequent retrieval with storage node preprocessing.

FIG. 5 is a flow diagram of an example of a process for retrieving training data with storage node preprocessing.

FIG. 6 is a block diagram of an example of a computing system in which selectively increasing a perfect row hammer count can be implemented.

FIG. 7 is a block diagram of an example of a multi-node network in which selectively increasing a perfect row hammer count can be implemented.

Descriptions of certain details and implementations follow, including non-limiting descriptions of the figures, which may depict some or all examples, and well as other potential implementations.

### DETAILED DESCRIPTION

As described herein, a system that executes a distributed application can have a processor node to generate a request for data and a storage node that stores the requested data. The distributed application can be a machine learning model or other distributed application that executes on a processor node, where the execution involves repeated access to data from the storage node. The processor node or the training node can offload preprocessing for the machine learning to the storage node. The processor node will use the data for iterative processing to train a machine learning model. The storage node receives the request for the data, reads the data, preprocess the data to perform data transformation on the data, and provides the preprocessed data to the processor node for the iterative processing.

In contrast to traditional systems that can offload preprocessing to a dedicated data preprocessing accelerator on the training server node or to a GPU (graphics processing unit), the system can offload preprocessing to the external storage. Offloading to the dedicated accelerator or to the GPU both involve increased system cost. Offloading to the storage node can free up processing bandwidth with minimal or no additional system cost.

The preprocessing can be preprocessing of random data samples requested by a machine learning application for generation of a machine learning model. The preprocessing is contrasted to, and can be in addition to, dedicated functions such as data compression or data encryption for communication or for storage. Rather, the preprocessing involves data transformation to prepare the data for iterative processing for the machine learning model.

The preprocessing by the external storage can enable data augmentation on training data before it is provided to a dedicated machine learning or artificial intelligence (AI) processor, such as a central processing unit (CPU) executing a machine learning application, a GPU accelerator, or other dedicated accelerator processor. Traditionally, a training node is implemented in a server that includes a CPU, memory resources, and one or more components of accelerator hardware. A machine learning system typically includes multiple training nodes or processor nodes.

The external storage can be a cluster or storage nodes that services a cluster or processor nodes. In one example, the external storage includes a CPU or dedicated special purpose processor to manage the interface to the storage nodes. In one example, the CPU or special purpose processor can perform the preprocessing. The external storage cluster can include a controller, which can be implemented as a processor or server to manage the distribution of data and data access requests to the storage nodes, and each storage node can include a processor or CPU to manage operations distributed to it.

In one example, the system enables on-demand control over specific preprocessing operations. For example, the system can include one or more triggers in a command that identify a specific operation to be performed on the data prior to providing it to the processor node for use in training. Thus, the processor node can generate a request for data with a specific request for a type of preprocessing, and the storage node can access the data and perform the specific operation on the data before sending it to the processor node.

In one example, the external storage and the storage nodes are object storage resources. Thus, the external storage can be computational storage, and more specifically, computational object storage. Object storage is understood as being different from file storage or block storage.

Generally, file storage or filesystem storage stores data in a hierarchical structure, and the hierarchy must be traversed to find the right folder that stores the requested data file. To access a file, the system needs to know the path to the correct folder where the data is stored. Generally, block storage separates files into individual blocks or chunks of data and stores them as separately addressable elements. Thus, individual blocks of data have different addresses, and there is no need to traverse a file structure to access the data. In addition, if file or block storage is provided to a processor node system via external storage cluster nodes, multiple nodes can host the file or block data.

Generally, object storage designates an item of data as an object, having a separate identifier and associated metadata. Object data is stored with its metadata, which increases flexibility for object storage to keep information about the data with the data. The unique identifier for the object operates as an address for the data, as the object data is stored in a flat structure.

Descriptions below refer to object storage, as the datasets for machine learning preprocessing are best supported by object storage, which allows any amount of unstructured data to be stored and accessed as whole objects, limited only by storage capacity. Application of preprocessing to block storage or file storage would be technically feasible, but impractical, due to the spreading of file or block data across multiple storage media devices and storage nodes. The media and nodes need to be traversed to construct the file or block data before preprocessing. However, it will be understood that application of preprocessing by storage could be accomplished in such systems.

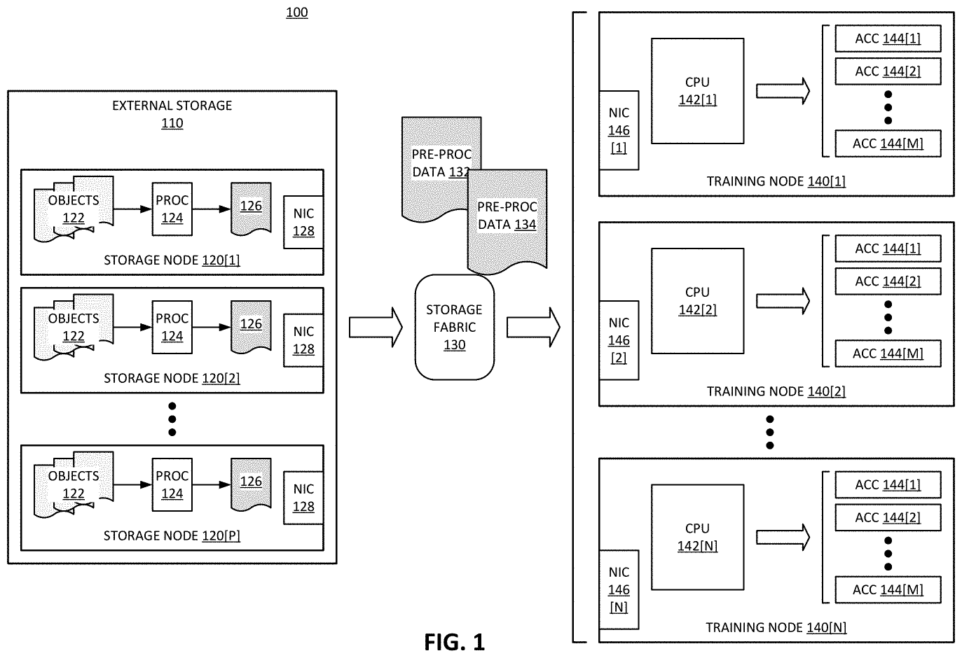

FIG. 1 is a block diagram of an example of a system with preprocessing resources in a storage node. System 100 is an example of a system with computation object storage. External storage 110 represents a cluster of P storage nodes, specifically, storage node 120[1:P], collectively storage nodes 120, where P is an integer. The cluster of storage nodes 120 provides storage of data for use by the cluster of processing nodes or processor nodes, identified as N training nodes 140[1:N], collectively training nodes 140, where N is an integer.

Training nodes 140[1:N] include corresponding CPUs (central processing units) 142[1:N], collectively CPUs 142. CPUs 142 represent single core or multicore processor devices. In one example, training nodes 140 each include M accelerators, which can be accelerator hardware such as a FPGA (field programmable gate array) or other programmable logic, graphics processors or GPUs, or other hardware to offload computations. System 100 represents the accelerators in each training node 140[1:N] as accelerators (ACC) 144[1:M], collectively accelerators 144, where M is an integer.

There is no required relationship between N, M, and P. There can be any number of training nodes, storage nodes, and accelerators. N, M, and P can all be different numbers, or any two can be the same number, or all three could potentially be the same number. It will be more common that at least two of the numbers are different from each other.

In one example, training nodes 140 are server devices. A server refers to a computer device, such as a rack-mounted server or blade server, including processing resources, memory (not specifically shown), network interface hardware (not specifically shown), local storage (not specifically shown) and software (not specifically shown) to execute on the processing resources.

Training nodes 140 couple to external storage 110 over storage fabric 130. System 100 can include other communication fabrics that are not specifically illustrated, such as a fabric interconnecting training nodes to allow the transfer of tasks between different processing nodes. Storage fabric 130 represents a communication network or communication infrastructure to connect storage nodes 120 to training nodes 140. In one example, storage fabric 130 represents an InfiniBand communication system available from the InfiniBand Trade Association. Alternatively, storage fabric 130 could be an Ethernet fabric, Fibre Channel fabric, or Omni-Path fabric available from INTEL Corporation.

In one example, storage nodes 120 include storage resources and a storage media device, such as one or more SSDs (solid state drives) or other storage drives, and a computing device having a processor, memory, and network interface hardware. In one example, storage nodes 120 provide file-based storage via objects hosting files. In one example, storage nodes provide object-based storage to training nodes 140.

In one example, system 100 performs machine learning by iterative processing operations in training nodes 140 based on data obtained from storage nodes 120. In one example, the machine learning can be visual deep learning, where storage nodes include multiple image objects or image files that are accessed by training nodes 140 for iterative processing. In one example, CPUs 142 access data from storage nodes 120 and provide data in a pipelined manner in batches to accelerators 144 for processing operations.

Training data can be stored in serialized binary format files (binary protocol buffer) to support data pipelining into the training frameworks efficiently. Examples can include TensorFlow TFRecord and PyTorch WebDataset formats. Training data can be split or sharded into multiple serialized files to feed to the different training nodes parallelly. Such splitting and sending of data in parallel can allow training nodes 140 to continue processing data instead of being starved, waiting for data. In one example, each binary format file is a sequence of records, with each such record containing a training sample. For example, for a visual processing environment, with a Resnet50/Imagenet data set, each TFRecord training file contains a sequence of TFRecords, each of which is a JPEG image (i.e., an image file compatible with the Joint Photographic Experts Group format) with associated meta data.

In system 100, storage nodes 120 perform preprocessing operations on training data prior to sending the data to training nodes 140. Storage nodes 120 are illustrated with objects 122, which represent raw training data stored in a storage device of the storage node. Processor (proc) 124 represents a processor or computing device at the storage node, which traditionally manages access to the storage resources of the storage node. In system 100, processor 124 performs one or more preprocessing operations to perform data transformation on the training data requested by the training nodes prior to providing the requested data. Processor 124 can be a CPU, special purpose processor, or accelerator dedicated for data preprocessing and transformation.

Block 126, illustrated in gray, represents the preprocessed object or object file. Preprocessed (PRE-PROC) data 132 and preprocessed (PRE-PROC) data 134 represent objects or files or streams of data provided to training nodes 140 from one or more storage nodes 120 over storage fabric 130. The data provided over storage fabric 130 can be preprocessed, to perform the data transformations requested on the data for the training operations.

In traditional systems, CPUs 142 would be responsible to either perform the preprocessing, or offload the preprocessing to processing resources within the training node. In contrast to such an approach, storage nodes 120 perform the preprocessing on the training data. As such, storage nodes 120 can optimize data for the data pipeline within the training framework being used. The operation by storage nodes 120 prevent CPUs 142 from needing to preprocess the data while the current batch is being trained on accelerators 144, as would traditionally be done.

System 100 illustrates a specific application to on-demand preprocessing as data is requested from training nodes 140. The same operations are applicable to other applications, such as offline batch inferencing, where large volumes of data can be preprocessed (e.g., image cropped and resized) and provided to training nodes 140 for performing inferencing. External storage 110 can be referred to as an external computational object storage (COS) solution that preprocesses data on demand to send to training nodes 140. In one example, as described in more detail below, the on-demand preprocessing can be performed with specifically requested data transformations for the training flow.

System 100 allows training based on large volumes of data (e.g., in the multiple terabytes), where the data does not fit in the volatile memory (e.g., DRAM (dynamic random access memory)) of the training node, requiring repeated fetching from storage. The repeated fetching from storage nodes 120 involves preprocessing at the storage nodes to prepare the data for training on CPUs 142. Thus, system 100 offloads preprocessing to storage nodes 120, which improves latency of the data pipeline, by not starving out CPUs 142 or accelerators 144 due to CPU processing bottlenecks that traditionally occur due to the CPU performing the data preprocessing. In system 100, the data provided (e.g., preprocessed data 132 and preprocessed data 134) by storage nodes 120 to training nodes 140 is already preprocessed.

In one example, system 100 can enable direct loading of data into accelerators 144 from storage nodes 120. For example, preprocessed data 132 and preprocessed data 134 are already preprocessed and ready for training operations/computations. Such data can be directly loaded into GPUs or accelerators 144 via peer-to-peer RDMA (remote direct memory access) from NIC (network interface circuit) hardware on training nodes 140 that are connected to storage nodes 120.

In one example, storage nodes 120 independently apply requested preprocessing functions on demand to data objects fetched from their independent storage resources. For example, different training nodes 140 can make requests for data with different preprocessing requests to different storage nodes, or to the same storage node at different times. As such, each data request can include a request for preprocessing that a receiving storage node 120 can apply to the data. In one example, processor 124 represents a CPU or primary processor of a control device of the storage node. In one example, processor 124 represents an accelerator or other processing hardware included in storage nodes 120 to perform preprocessing operations on demand at the storage nodes.

System 100 can represent a system for machine learning. Processor nodes (training nodes 140) can execute machine learning application software that generates a request for data from external storage 110. In one example, the request is a data request command that indicates preprocessing operations to perform on the data prior to providing the preprocessed data to the processor node. External storage 110 can direct the request to an individual storage node 120 or a selected storage node that stores the data, to access and preprocess the data. The preprocessing can include specific preprocessing operations indicated in the request. The storage node can provide the preprocessed data to the requesting processor node, which can then perform iterative processing on the data to train a machine learning model.

In one example, storage nodes 120 of external storage 100 include NIC (network interface circuit) 128. NIC 128 represents a circuit or a card that enables storage nodes 120 to access storage fabric 130. Through NIC 128, storage nodes 120 can receive requests and data from training nodes 140 and send data to the training nodes. In one example, training nodes 140[1:N] include NICs 146[1:N], respectively, collectively, NICs 146. NICs 146 represent circuits or cards that enable individual training nodes 140 to access storage fabric 130. Through NICs 146, training nodes 140 can send requests and data to storage nodes 120 and receive data in response to read requests to the storage nodes.

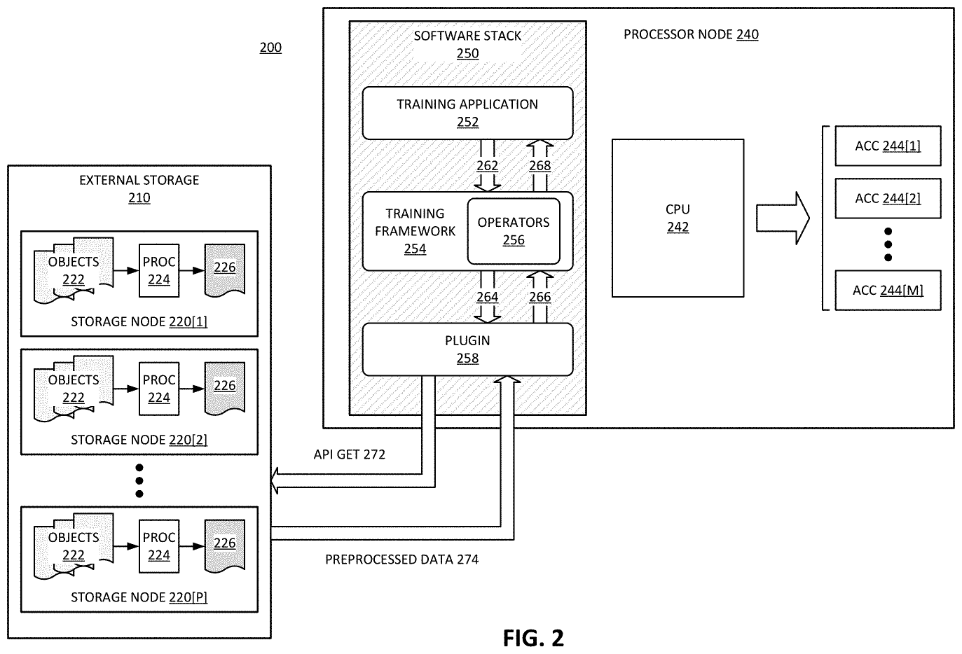

FIG. 2 is a block diagram of an example of a system with a software framework to support storage node preprocessing offloading. System 200 represents a system in accordance with system 100, where storage nodes provide preprocessing on data to send to a processing node. System 200 includes external storage 210 coupled to processor node 240. Processor node 240 is one of N processor nodes in a cluster of nodes for training, where the other nodes are not specifically illustrated.

External storage 210 includes P storage nodes, illustrated as storage nodes 220[1:P], collectively storage nodes 220. Storage nodes 220 include objects 222 or other data stored at the nodes, processor (PROC) 224 to perform preprocessing operations on data read or fetched from storage, and block 226 to represent preprocessed data.

Processor node 240 represents a training node. Processor node 240 includes CPU 242, which represents one or more processor devices for the processor node. In one example, processor node 240 includes M accelerators, identified as accelerators (ACC) 244[1:M], collectively accelerators 244. CPU 242 can offload iterative machine learning processing tasks to accelerators 244.

Processor node 240 includes software stack 250, which represents a software stack for the machine learning training. Software stack 250 can represent multiple software components and the data pipeline or operation workflow through the software components. Each software component can be an agent or application executing on CPU 242 or accelerator 244 or both CPU 242 and accelerator 244. The software components represent the control logic provided for machine learning, which is executed by hardware resources of processor node 240.

In one example, software stack 250 includes training application 252, which represents a training application that manages the storing of data in external storage 210, the retrieving of data from the external storage, and the operations within processor node 240 by CPU 242 and accelerators 244 for training. Software stack 250 can include training framework 254 to provide software features callable or executable by training application 252. Training framework 254 can include multiple operators 256, which represent functions controllable by the data pipeline for data. Plugin 258 represents one or more software components that interface with external storage 210, enabling the generation of specific commands to store or retrieve data from the COS.

In one example, training application 252 stores a serialized data record file or multiple data records file as one or more objects into external storage 210 (COS). The storing can be performed by an API (application programming interface) of training application 252, training framework 254, and plugin 258. As a specific example, an implementation of system 200 could enable training application 252 to store data through a REST API via framework 254 and plugin 258.

In one example, through plugin 258, the REST API PUT call to external storage 210 can include additional custom metadata to indicate the format of the object and the ability requested from storage for preprocessing on the stored object on demand. For example, in the application of system 200 to a visual deep learning system, training application 252 could indicate a TFRecord file with JPEG data to external storage 210, indicating one or more preprocessing operations desired to be performed on demand upon request of the data from storage. In one example, the metadata for the object includes an indication that preprocessing is ON, indicating that the application wants to be able to execute various preprocessing operations on the data.

In one example, upon receiving a PUT request or other store command with preprocessing indicated (e.g., preprocessing metadata value=ON), external storage 210 (the COS target) can store the entire object on a single storage node and not spread the data across multiple storage nodes. Spreading data across storage nodes 220 is a typical storage solution. Storing an entire object in a selected storage node can enable the storage node to hold the entire data record and enable subsequent preprocessing without having to access the data from other storage nodes. System 200 can thus enable preprocessing of an object in its entirety on a selected storage node in response to a subsequent data request command (e.g., a GET request). Having the whole object in one storage node avoids the need for reassembling data from across storage nodes 220 before processing, which can avoid access latency. In one example, external storage 210 will spread different objects across different storage nodes 220 for parallel throughput. An object can be single record (e.g., one TFRecord) or a subset of records (e.g., TFRecords file).

In one example, external storage 210 supports processing functions that training application 252 can invoke during a data request command (e.g., a storage REST API GET call). Processing function examples for image processing can include image-decode, image-resize, image-normalize, random-flip, random-crop, or other functions. For other machine learning applications (i.e., machine learning other than image processing), external storage 210 can support different processing functions to prepare the data for the processor nodes to use for the machine learning model. In one example, the data request can be a command that includes metadata to indicate one or more preprocessing functions or operations to perform on the requested data

In one example, plugin 258 represents a software plugin integration for training framework 254, which enables the framework to support requests for preprocessed objects, and then to support receiving preprocessed objects from storage. In one example, plugin 258 supports API calls in training framework 254 for training application 252. Operators 256 represent operators that can be enabled by plugin 258. For example, training framework 254 can include a data pipeline operator defined along with a data preprocessing operator for each supported preprocessing function, which plugin 258 executes.

In one example, training application 252 can invoke operators 256 on demand on training data and the software layer will pass on handling of the operations to external storage 210 via API calls or other commands. In one example, operators 256 can enable offloading preprocessing from processor node 240 to a selected storage node 220.

System 200 illustrates an example of the data flow or the data pipeline the machine learning. Arrow 262 from training application 252 to training framework 254 represents a request for data or for a data stream. In one example, the request includes metadata to request specific preprocessing operations. Training framework 254 can enable the request via one or more operators 256 defined to generate the data request command to send to external storage 210 via plugin 258.

Arrow 264 from training framework 254 to plugin 258 represents the parameters of operators 256 with the request. Plugin 258 can generate the request for software stack 250 and for processor node 240, represented as API GET 272 provided to external storage 210. In response to API GET 272, a controller of external storage 210 selects one of storage nodes 220 to service the request, based on where the requested data is located.

The selected storage node can read the data, implement the requested preprocessing, and return preprocessed data 274. Plugin 258 can enable identification of the returned data as being fully preprocessed. Arrow 266 from plugin 258 to training framework 254 represents the understanding of the return data as preprocessed. In one example, preprocessed data 274 can include metadata to indicate which preprocessing operations were applied, which can be recognized in training framework via operators 256. Arrow 268 represents providing the preprocessed data to training application 252, which can then distribute the data to CPU 242 for training processing.

In one example, operators 256 can add metadata to a store command to cause external storage to store one or more data objects to support subsequent preprocessing and offload with a data access request. In one example, operators 256 represent data pipeline operations exposed as a service that plugin 258 understands. In one example, plugin 258 includes an API store command (e.g., a PUT call) with extensions to indicate that a data object should be stored in a way to support preprocessing functions later during retrieval. In one example, plugin 258 includes an API read command (e.g., a GET call) with extensions to indicate one or more preprocessing functions to be applied on retrieved data prior to returning it to the processor node.

In one example, plugin 258 and operators 256 provide API extension for training framework 254 for training application 252 to invoke to support preprocessing offload to external storage 210. The ability of training application 252 to invoke the extensions can enable the application to request specific preprocessing offload functions on a data record. The request for specific preprocessing functions can be on demand, and different for different records, for different storage nodes, or for different requests (whether to the same storage node or to different storage nodes). For example, on-demand preprocessing can enable training application 252 to request Function X on a first record from storage node 220[1], Function Y on a second record from storage node 220[2], and Functions X, Y, and Z on a third record from storage node 220[1]. It will be understood that other combinations of functions can be requested on demand for different data, data requests, and storage nodes.

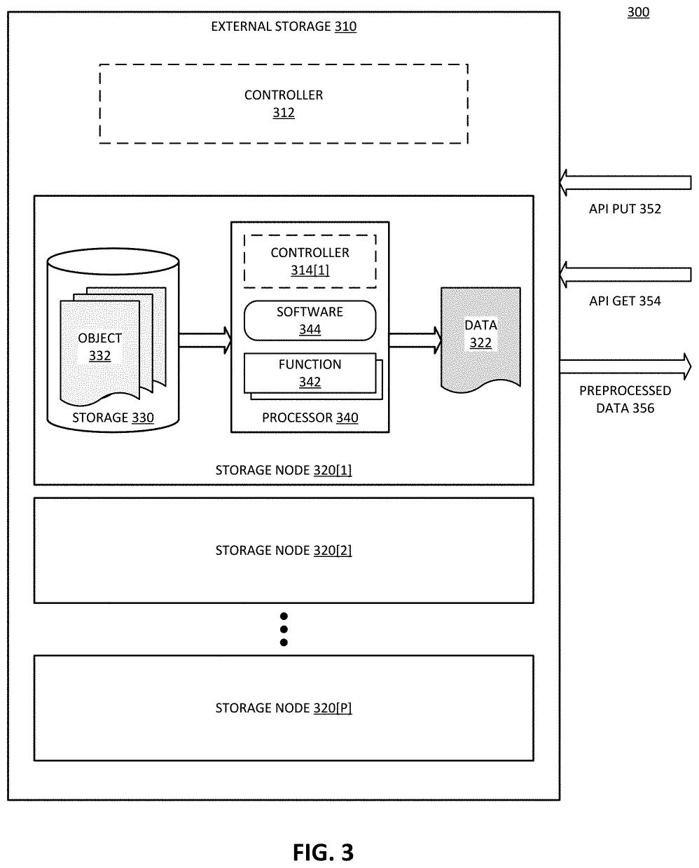

FIG. 3 is a block diagram of an example of a storage device with multiple storage nodes to implement preprocessing offloading. System 300 represents a system in accordance with an example of system 100 or system 200. System 300 illustrates external storage 310, while the training node cluster is not specifically illustrated.

In one example, external storage 310 optionally includes controller 312, which can represent a server or computer device that manages distribution of data for storage to a cluster of storage nodes, and manages distribution of data requests to the storage nodes. The controller can also be distributed internal to each storage node 320 instead of being a separate external device for the same purpose. Controller 314[1] represents a distributed controller executed by processor 340 of storage node 320[1]. Other storage nodes would also include respective controllers 314[i] executed by their respective processors.

External storage 310 is illustrated with P nodes, identified as storage nodes 320[1:P], collectively storage nodes. System 300 only illustrates details of storage node 320[1], but the internal details of the other storage nodes will be similar. It will be understood that there is no requirement that each storage node have the same type of hardware or the same amount of storage. Rather, individual storage nodes can have different storage capacity and different capabilities.

Storage node 320[1] includes storage 330, which represents one or more storage devices for the node. The storage devices can include spinning hard disks, solid state drive (SSDs), nonvolatile random access memory devices such as Optane available from Intel Corporation, or other storage media, or a combination of storage media. Storage 330 stores one or more objects 332 or files or stores data in another format. Objects 332 represent the data stored at storage node 320[1] and available to be read from the storage node.

Storage node 320[1] includes processor 340. In one example, processor 340 represents a CPU or GPU of a computer device that is part of storage node 320[1]. In one example, storage node 320[1] includes a server or other computer device and multiple storage devices 330. In one example, processor 340 represents an accelerator device or other processor or processing hardware (e.g., FPGA or ASIC (application specific integrated circuit)) to provide preprocessing operations for storage node 320[1].

Processor 340 includes functionality represented by functions 342. Functions 342 represent the different types of preprocessing operations that can be requested to be performed on data read from storage node 320[1]. In one example, one or more functions 342 can be built directly into a hardware solution. In one example, one or more functions 342 are implemented by the execution of software 344 on processor 340. Software 344 represents any type of application, agent, or function logic programmed into the storage node, which processor 340 will execute.

In one example, the processor node can request the application of one or more functions to randomize the data, which can improve the diversity of the training data. For example, in computer vision models (e.g., Resnet50), preprocessing the image data before training a batch of data on a GPU or accelerator can include one or more of the following: image decoding; image resizing; execution of a random crop; execution of a random horizontal flip; normalization of an image to preconfigured image parameters; image transposition; or other operations. Data 322 represents the fetched data after the application of preprocessing requested by processor 340.

System 300 illustrates API PUT 352 as an input to external storage 310. API PUT 352 represents a data store command or a data store request to store data into one of storage nodes 320. In one example, in response to API PUT 352, controller 312 selects one of storage nodes 320 to store the data. API PUT 352 can indicate how external storage 310 is to store the data to support subsequent preprocessing when the data is requested. Controller 312 can forward a request to a selected storage node 320 for servicing by the storage node. Forwarding the request to the selected storage node can trigger the storage node to process the request. For example, in response to the command, controller 312 can select a single storage node 320 to store the data, rather than spreading the data across multiple storage nodes. By placing the data in a single storage node, the selected storage node can apply preprocessing without needing to access data from other storage nodes.

In one example, in response to receiving API PUT 352, controller 314 identifies a selected storage node of storage nodes 320 to store the data. If the storage node of which controller 314 is a part, controller 314 can trigger the storage node to process the request. API PUT 352 can indicate how external storage 310 is to store the data to support subsequent preprocessing when the data is requested.

System 300 illustrates API GET 354 as an input to external storage 310. API GET 354 represents a data read command or data request received from a processor node. In response to API GET 354, in one example, controller 312 can identify where the data is stored and provide the request to the selected storage node to trigger the selected storage node to process the request. In response to API GET 354, in one example, controller 314 can identify where the data is stored and trigger the selected storage node to process the request. In one example, API GET 354 includes an indication of one or more preprocessing operations requested on the data by the processor node. In response to the request, the selected storage node 320 reads the data from storage, performs the preprocessing requested, and provides the data back to the processor node.

System 300 illustrates preprocessed data 356 as an output from external storage 310. Preprocessed data 356 represents data from a selected storage node 320, which has been preprocessed and is ready to return to the requesting processor node. In one example, the selected storage node provides data 322 directly to the processor node as preprocessed data 356. In one example, when the selected storage node generates data 322, controller 312 can manage the sending of the data as preprocessed data 356 to the processor node. In such a case, the storage node can provide the preprocessed data indirectly to the processor node via controller 312.

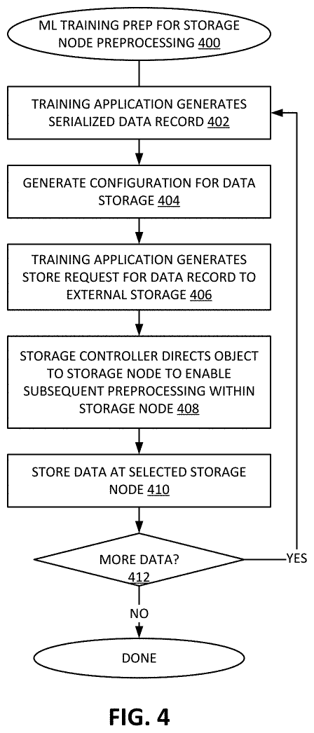

FIG. 4 is a flow diagram of an example of a process for storing training data for subsequent retrieval with storage node preprocessing. Process 400 represents a process for machine learning (ML) training preparation for storage node preprocessing. The storage node preprocessing preparation can refer to control over how the data is stored to support subsequent retrieval with preprocessing by the storage node.

In one example, a training application of a training node or a processor node generates a serialized data record, at 402. The serialized data record represents data to be used to execute a machine learning model. The training application can generate one or more configuration settings for the data storage to store the data, at 404. The configuration settings relate to what the data is, how it will be used in the model, and how the data will be stored in external storage to support subsequent preprocessing at the storage node.

The training application can generate a store request to store the data record to external storage, at 406. In one example, the request can include hints or metadata to indicate how to store the data to support subsequent preprocessing. For example, the request can indicate to the external storage to store the data in a non-distributed manner or with a non-distributed layout to enable accessing the data from a single storage node and preventing having to gather data from multiple sources before applying the preprocessing. The external storage can thus receive hints or an indication of how to store the data in a manner suitable for preprocessing, such as by not distributing the data, or by storing the data in a storage node having preprocessing capability, assuming a system has mixed storage nodes where some nodes support preprocessing and other nodes do not support preprocessing.

In one example, the store request includes one or more indicators to the external storage about the application of preprocessing on the data. For example, the store request can simply include an indicator that storage node preprocessing is ‘ON’, or the training application wants the storage node to be able to apply preprocessing functions when the data is later retrieved. In one example, the request passes through a software stack from a training application to operators in the training framework using framework API calls. From the training framework, the request can be passed to the external storage system via the plugin using API calls.

The storage controller directs an object to a storage node to enable subsequent preprocessing within the storage node when the training application indicates subsequent preprocessing in the store request, at 408. The selected storage node can store the data, at 410. If the data stored is not the last of the data to store at the storage nodes, at 412 YES branch, the external storage can process another data record from the training application, at 402. When there is no more data to store, at 412 NO branch, the process can complete.

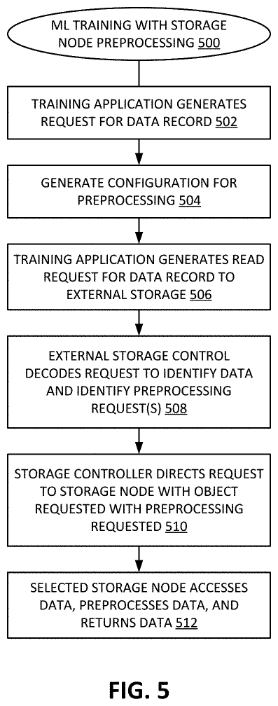

FIG. 5 is a flow diagram of an example of a process for retrieving training data with storage node preprocessing. Process 500 represents a process for machine learning (ML) training with storage node preprocessing.

In one example, the training application generates a request for a data record from external storage, at 502. In one example, the training application generates configuration information for the preprocessing to be applied to the data record, at 504. The training application can generate a read request for the data record to the external storage, at 506. The read request identifies the data to be used for iterative processing by the processor node, and can include one or more indications of preprocessing operations to perform on the data. In one example, the request passes through a software stack from a training application to operators in the training framework using framework API calls. From the training framework, the request can be passed to the external storage system via the plugin using API calls.

In response to the read request, the storage controller decodes the request to identify the data and identify preprocessing request(s) associated with the data request, at 508. The external storage control can direct the request to a selected storage node with the object requested with the preprocessing requested, at 510. In response to the request, the selected storage node accesses the requested data, preprocesses the data with the preprocessing operations requested, and returns the data to the training application, at 512.

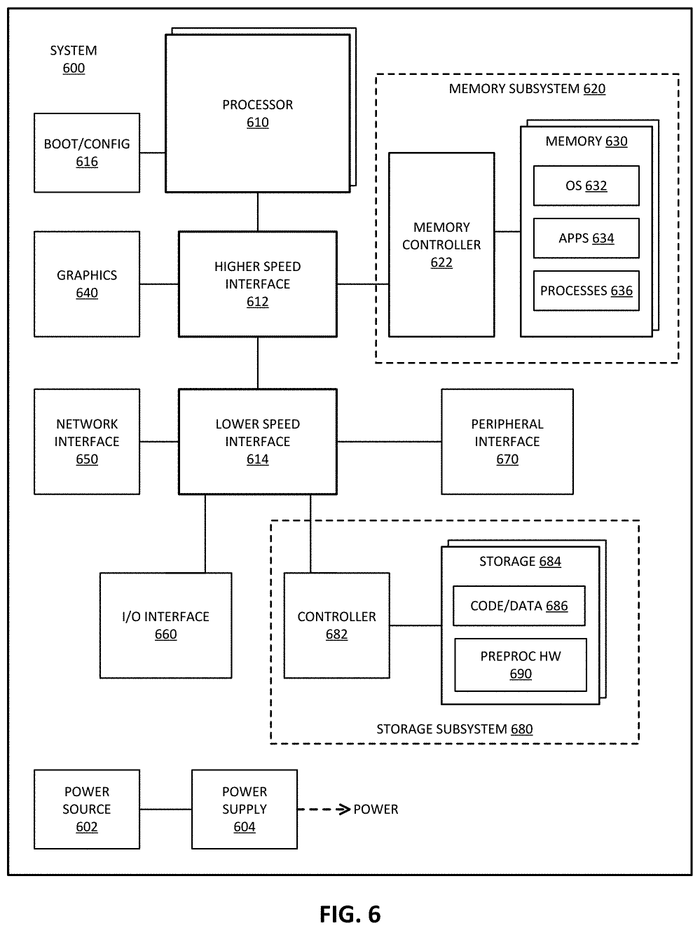

FIG. 6 is a block diagram of an example of a computing system in which selectively increasing a perfect row hammer count can be implemented. System 600 represents a computing device in accordance with any example herein, and can be a laptop computer, a desktop computer, a tablet computer, a server, a gaming or entertainment control system, embedded computing device, or other electronic device.

System 600 represents a storage node or processor node in accordance with an example of storage nodes 120 or training nodes 140 of system 100, an example of storage nodes 220 or processor node 240 of system 200, or an example of storage nodes 320 of system 300. In one example, storage 684 includes preprocessing (PREPROC) hardware (HW) 690. Storage 684 can represent storage of a storage node that stores data to support machine learning processing by a processor node. Preprocessing hardware 690 enables system 600 to perform preprocessing on data retrieved from storage 684 prior to returning it to the processor node. In one example, processor 610 is preprocessing hardware 690.

System 600 includes processor 610 can include any type of microprocessor, central processing unit (CPU), graphics processing unit (GPU), processing core, or other processing hardware, or a combination, to provide processing or execution of instructions for system 600. Processor 610 can be a host processor device. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or a combination of such devices.

System 600 includes boot/config 616, which represents storage to store boot code (e.g., basic input/output system (BIOS)), configuration settings, security hardware (e.g., trusted platform module (TPM)), or other system level hardware that operates outside of a host OS. Boot/config 616 can include a nonvolatile storage device, such as read-only memory (ROM), flash memory, or other memory devices.

In one example, system 600 includes interface 612 coupled to processor 610, which can represent a higher speed interface or a high throughput interface for system components that need higher bandwidth connections, such as memory subsystem 620 or graphics interface components 640. Interface 612 represents an interface circuit, which can be a standalone component or integrated onto a processor die. Interface 612 can be integrated as a circuit onto the processor die or integrated as a component on a system on a chip. Where present, graphics interface 640 interfaces to graphics components for providing a visual display to a user of system 600. Graphics interface 640 can be a standalone component or integrated onto the processor die or system on a chip. In one example, graphics interface 640 can drive a high definition (HD) display or ultra high definition (UHD) display that provides an output to a user. In one example, the display can include a touchscreen display. In one example, graphics interface 640 generates a display based on data stored in memory 630 or based on operations executed by processor 610 or both.

Memory subsystem 620 represents the main memory of system 600, and provides storage for code to be executed by processor 610, or data values to be used in executing a routine. Memory subsystem 620 can include one or more varieties of random-access memory (RAM) such as DRAM, 3DXP (three-dimensional crosspoint), or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610, such as integrated onto the processor die or a system on a chip.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or other bus, or a combination.

In one example, system 600 includes interface 614, which can be coupled to interface 612. Interface 614 can be a lower speed interface than interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can exchange data with a remote device, which can include sending data stored in memory or receiving data to be stored in memory.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, NAND, 3DXP, or optical based disks, or a combination. Storage 684 holds code or instructions and data 686 in a persistent state (i.e., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (i.e., the value or state of the data is indeterminate if power is interrupted to system 600). In one example, storage subsystem 680 includes controller 682 to interface with storage 684. In one example controller 682 is a physical part of interface 614 or processor 610, or can include circuits or logic in both processor 610 and interface 614.

Power source 602 provides power to the components of system 600. More specifically, power source 602 typically interfaces to one or multiple power supplies 604 in system 600 to provide power to the components of system 600. In one example, power supply 604 includes an AC to DC (alternating current to direct current) adapter to plug into a wall outlet. Such AC power can be renewable energy (e.g., solar power) power source 602. In one example, power source 602 includes a DC power source, such as an external AC to DC converter. In one example, power source 602 or power supply 604 includes wireless charging hardware to charge via proximity to a charging field. In one example, power source 602 can include an internal battery or fuel cell source.

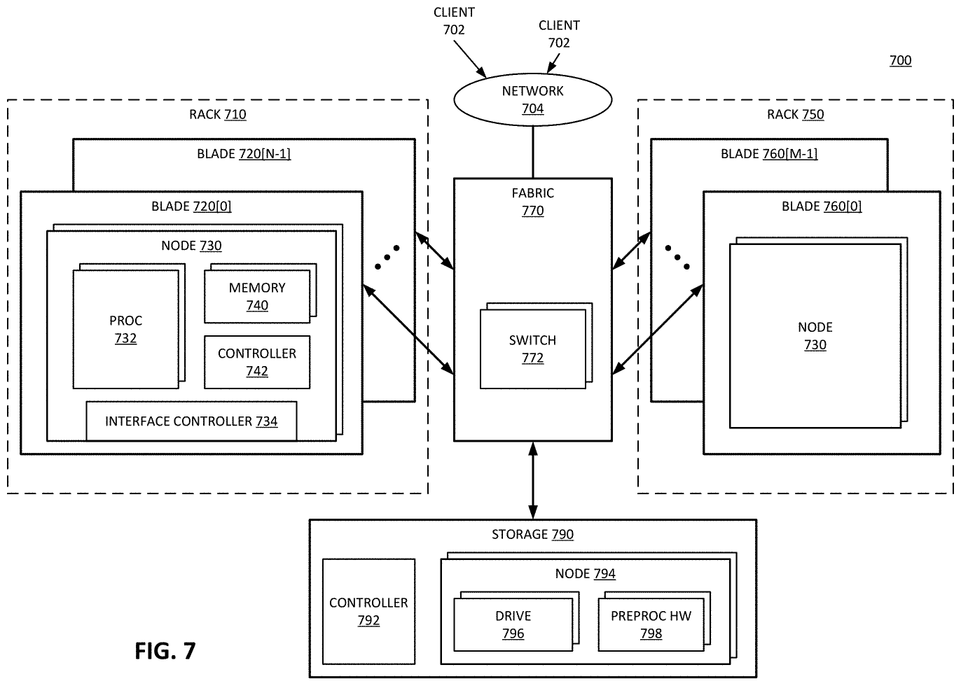

FIG. 7 is a block diagram of an example of a multi-node network in which selectively increasing a perfect row hammer count can be implemented. System 700 represents a network of nodes. In one example, system 700 represents a data center. In one example, system 700 represents a server farm. In one example, system 700 represents a data cloud or a processing cloud.

System 700 represents a system in accordance with an example of system 100, an example of system 200, or an example of system 300. In one example, node 730 represents a processor node to perform machine learning operations. Storage 790 represents external storage to store data for the processor nodes. In one example, storage 790 includes controller 792 to control distribution of data and requests among storage nodes 794. Storage nodes 794 include storage resources represented by drives 796 and preprocessing (PREPROC) hardware (HW) 798. Preprocessing hardware 798 enables storage 790 to perform preprocessing on data retrieved from storage node 794 prior to returning it to the processor node.

One or more clients 702 make requests over network 704 to system 700. Network 704 represents one or more local networks, or wide area networks, or a combination. Clients 702 can be human or machine clients, which generate requests for the execution of operations by system 700. System 700 executes applications or data computation tasks requested by clients 702.

In one example, system 700 includes one or more racks, which represent structural and interconnect resources to house and interconnect multiple computation nodes. In one example, rack 710 includes multiple nodes 730. In one example, rack 710 hosts multiple blade components 720. Hosting refers to providing power, structural or mechanical support, and interconnection. Blades 720 can refer to computing resources on printed circuit boards (PCBs), where a PCB houses the hardware components for one or more nodes 730. In one example, blades 720 do not include a chassis or housing or other “box” other than that provided by rack 710. In one example, blades 720 include housing with exposed connector to connect into rack 710. In one example, system 700 does not include rack 710, and each blade 720 includes a chassis or housing that can stack or otherwise reside in close proximity to other blades and allow interconnection of nodes 730.

System 700 includes fabric 770, which represents one or more interconnectors for nodes 730. In one example, fabric 770 includes multiple switches 772 or routers or other hardware to route signals among nodes 730. Additionally, fabric 770 can couple system 700 to network 704 for access by clients 702. In addition to routing equipment, fabric 770 can be considered to include the cables or ports or other hardware equipment to couple nodes 730 together. In one example, fabric 770 has one or more associated protocols to manage the routing of signals through system 700. In one example, the protocol or protocols is at least partly dependent on the hardware equipment used in system 700.

As illustrated, rack 710 includes N blades 720. In one example, in addition to rack 710, system 700 includes rack 750. As illustrated, rack 750 includes M blades 760. M is not necessarily the same as N; thus, it will be understood that various different hardware equipment components could be used, and coupled together into system 700 over fabric 770. Blades 760 can be the same or similar to blades 720. Nodes 730 can be any type of node and are not necessarily all the same type of node. System 700 is not limited to being homogenous, nor is it limited to not being homogenous.

For simplicity, only the node in blade 720[0] is illustrated in detail. However, other nodes in system 700 can be the same or similar. At least some nodes 730 are computation nodes, with processor (proc) 732 and memory 740. A computation node refers to a node with processing resources (e.g., one or more processors) that executes an operating system and can receive and process one or more tasks. In one example, at least some nodes 730 are server nodes with a server as processing resources represented by processor 732 and memory 740. A storage server refers to a node with more storage resources than a computation node, and rather than having processors for the execution of tasks, a storage server includes processing resources to manage access to the storage nodes within the storage server.

In one example, node 730 includes interface controller 734, which represents logic to control access by node 730 to fabric 770. The logic can include hardware resources to interconnect to the physical interconnection hardware. The logic can include software or firmware logic to manage the interconnection. In one example, interface controller 734 is or includes a host fabric interface, which can be a fabric interface in accordance with any example described herein.

Processor 732 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory 740 can be or include memory devices, managed by a memory controller, represented by controller 742.

In general with respect to the descriptions herein, in one example a system for execution of a distributed application includes: a processor node to generate a request for data and perform iterative processing on the data to train a machine learning model; and an external storage including multiple storage nodes having a processor device, the external storage to receive the request for the data, read the data from a selected storage node, preprocess the data with the processor device of the storage node to perform data transformation on the data, and provide preprocessed data to the processor node for the iterative processing.

In one example of the system, the external storage comprises a computational object storage system. In accordance with any preceding example of the system, in one example, the external storage is to store the data on a single storage node for subsequent preprocessing. In accordance with any preceding example of the system, in one example, the storage node is to perform on-demand preprocessing in response to the request for the data. In accordance with any preceding example of the system, in one example, different storage nodes of the multiple storage nodes are to apply different on-demand preprocessing operations based on data requested. In accordance with any preceding example of the system, in one example, the request for the data comprises a data request command to indicate preprocessing operations to perform on the data prior to providing the preprocessed data to the processor node. In accordance with any preceding example of the system, in one example, the external storage is to store data in the storage nodes in response to a data store command, where the data store command is to indicate to the external storage how to store data to support application of preprocessing. In accordance with any preceding example of the system, in one example, the processor node includes a software stack with application programming interface (API) extensions to generate commands to trigger preprocessing operations by the external storage and to trigger hints or metadata to store data for subsequent preprocessing. In accordance with any preceding example of the system, in one example, the software stack includes a training application to specify preprocessing functions to offload to the external storage and data storage hints or metadata to external storage. In accordance with any preceding example of the system, in one example, the commands further trigger hints to store data in preparation for the subsequent preprocessing. In accordance with any preceding example of the system, in one example, the preprocessing includes one or more of: image decoding; image resizing; execution of a random crop; execution of a random horizontal flip; normalization of an image to preconfigured image parameters; or, image transposition.

In general with respect to the descriptions herein, in one example a storage device includes: multiple storage nodes including storage and a processor device; and a storage controller to receive from a processor node a request for data for iterative processing to train a machine learning model, identify a selected storage node of the multiple storage nodes where the requested data is stored, and trigger the selected storage node to process the request; wherein, in response to the request, the selected storage node is to read the requested data, preprocess the data with the processor device to perform data transformation on the requested data, and provide preprocessed data to send to the processor node.

In one example of the storage device, the storage nodes comprise computational object storage, wherein the storage controller is to cause a single storage node to store a data object for subsequent preprocessing. In accordance with any preceding example of the storage device, in one example, the selected storage node is to perform on-demand preprocessing in response to the request, wherein different storage nodes of the multiple storage nodes are to apply different on-demand preprocessing operations in response to different requests for data. In accordance with any preceding example of the storage device, in one example, the request for the data comprises a data request command to indicate preprocessing operations to perform on the data prior to providing the preprocessed data to the processor node. In accordance with any preceding example of the storage device, in one example, the storage controller comprises a controller external to the storage nodes, or a controller distributed on the storage nodes. In accordance with any preceding example of the storage device, in one example, the storage controller is to store data in the selected storage node in response to a data store command, where the data store command is to indicate how to store data to support application of preprocessing. In accordance with any preceding example of the storage device, in one example, the storage controller to receive the request from the processor node comprises the storage controller to receive the request generated by an application programming interface (API) of a software stack of the processor node, the API to generate commands to trigger preprocessing and store operations by the storage device. In accordance with any preceding example of the storage device, in one example, the software stack includes a training application to specify preprocessing functions to offload to the storage device and store functions to store the data with a non-distributed layout. In accordance with any preceding example of the storage device, in one example, preprocess the data includes performance one or more of: image decoding; image resizing; execution of a random crop; execution of a random horizontal flip; normalization of an image to preconfigured image parameters; or, image transposition.

In general with respect to the descriptions herein, in one example a method for data access includes: identifying data for iterative processing to train a machine learning model at a processor node; generating a request for the data from an external storage device; and sending the request to trigger a storage node of the external storage device to read the data, preprocess the data to perform data transformation on the data prior to returning the data to the processor node.

In one example of the method, generating the request comprises identifying a preprocessing operation to perform on the data by the storage node. In accordance with any preceding example of the method, in one example, the external storage device comprises a computational object storage system. In accordance with any preceding example of the method, in one example, the external storage device is to store the data on a single storage node for subsequent preprocessing. In accordance with any preceding example of the method, in one example, the storage node is to perform on-demand preprocessing in response to the request for the data. In accordance with any preceding example of the method, in one example, different storage nodes of the external storage device are to apply different on-demand preprocessing operations based on data requested. In accordance with any preceding example of the method, in one example, generating the request comprises identifying a preprocessing operation to perform on the data by the storage node. In accordance with any preceding example of the method, in one example, generating the request comprises indicating to the external storage device how to store data to support application of preprocessing. In accordance with any preceding example of the method, in one example, generating the request comprises generating commands with a software stack with application programming interface (API) extensions to trigger preprocessing operations by the external storage device and to trigger hints or metadata to store data for subsequent preprocessing. In accordance with any preceding example of the method, in one example, preprocessing includes one or more of: image decoding; image resizing; execution of a random crop; execution of a random horizontal flip; normalization of an image to preconfigured image parameters; or, image transposition.

In general with respect to the descriptions herein, in one example a system for execution of a distributed application includes: a processor node to generate a request for data and perform iterative processing on the data to train a machine learning model; wherein the processor node is to generate a request for data and send the request to an external storage having multiple storage nodes with a processor device, the request to trigger a selected storage node to read the data, preprocess the data with the processor device of the storage node to perform data transformation on the data, and provide preprocessed data to the processor node for the iterative processing.

In one example of the system, the processor node includes a software stack with application programming interface (API) extensions to generate commands to trigger preprocessing operations by the external storage and to trigger hints or metadata to store data for subsequent preprocessing. In accordance with any preceding example of the system, in one example, the software stack includes a training application to specify preprocessing functions to offload to the external storage and data storage hints or metadata to external storage. In accordance with any preceding example of the system, in one example, the commands further trigger hints to store data in preparation for the subsequent preprocessing. In accordance with any preceding example of the system, in one example, the system includes: a computational object storage system as the external storage. In accordance with any preceding example of the system, in one example, the external storage is to store the data on a single storage node for subsequent preprocessing. In accordance with any preceding example of the system, in one example, the storage node is to perform on-demand preprocessing in response to the request for the data. In accordance with any preceding example of the system, in one example, different storage nodes of the multiple storage nodes are to apply different on-demand preprocessing operations based on data requested. In accordance with any preceding example of the system, in one example, the request for the data comprises a data request command to indicate preprocessing operations to perform on the data prior to providing the preprocessed data to the processor node. In accordance with any preceding example of the system, in one example, the external storage is to store data in the storage nodes in response to a data store command, where the data store command is to indicate to the external storage how to store data to support application of preprocessing. In accordance with any preceding example of the system, in one example, to preprocess the data includes one or more of: image decoding; image resizing; execution of a random crop; execution of a random horizontal flip; normalization of an image to preconfigured image parameters; or, image transposition.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A system for execution of a distributed application, comprising:
a processor node to generate a request for data and perform iterative processing on the data to train a machine learning model;
wherein the processor node is to generate a request for data and send the request to an external storage having multiple storage nodes with a processor device, the request to trigger a selected storage node to read the data, preprocess the data with the processor device of the storage node to perform data transformation on the data, and provide preprocessed data to the processor node for the iterative processing.

2. The system of claim 1, wherein the processor node includes a software stack with application programming interface (API) extensions to generate commands to trigger preprocessing operations by the external storage and to trigger hints or metadata to store data for subsequent preprocessing.

3. The system of claim 2, wherein the software stack includes a training application to specify preprocessing functions to offload to the external storage and data storage hints or metadata to external storage.

4. The system of claim 2, wherein the commands further trigger hints to store data in preparation for the subsequent preprocessing.

5. The system of claim 1, further comprising:
a computational object storage system as the external storage.

6. The system of claim 5, wherein the external storage is to store the data on a single storage node for subsequent preprocessing.

7. The system of claim 5, wherein the storage node is to perform on-demand preprocessing in response to the request for the data.

8. The system of claim 7, wherein different storage nodes of the multiple storage nodes are to apply different on-demand preprocessing operations based on data requested.

9. The system of claim 7, wherein the request for the data comprises a data request command to indicate preprocessing operations to perform on the data prior to providing the preprocessed data to the processor node.

10. The system of claim 5, wherein the external storage is to store data in the storage nodes in response to a data store command, where the data store command is to indicate to the external storage how to store data to support application of preprocessing.

11. The system of claim 1, wherein to preprocess the data includes one or more of:
image decoding;
image resizing;
execution of a random crop;
execution of a random horizontal flip;
normalization of an image to preconfigured image parameters; or,
image transposition.

12. A storage device, comprising:
multiple storage nodes including storage and a processor device; and
a storage controller to receive from a processor node a request for data for iterative processing to train a machine learning model, identify a selected storage node of the multiple storage nodes where the requested data is stored, and trigger the selected storage node to process the request;
wherein, in response to the request, the selected storage node is to read the requested data, preprocess the data with the processor device to perform data transformation on the requested data, and provide preprocessed data to send to the processor node.

13. The storage device of claim 12, wherein the storage nodes comprise computational object storage, wherein the storage controller is to cause a single storage node to store a data object for subsequent preprocessing.

14. The storage device of claim 12, wherein the selected storage node is to perform on-demand preprocessing in response to the request, wherein different storage nodes of the multiple storage nodes are to apply different on-demand preprocessing operations in response to different requests for data.

15. The storage device of claim 14, wherein the request for the data comprises a data request command to indicate preprocessing operations to perform on the data prior to providing the preprocessed data to the processor node.

16. The storage device of claim 12, wherein the storage controller comprises a controller external to the storage nodes, or a controller distributed on the storage nodes.

17. The storage device of claim 12, wherein the storage controller is to store data in the selected storage node in response to a data store command, where the data store command is to indicate how to store data to support application of preprocessing.

18. The storage device of claim 12, wherein the storage controller to receive the request from the processor node comprises the storage controller to receive the request generated by an application programming interface (API) of a software stack of the processor node, the API to generate commands to trigger preprocessing and store operations by the storage device.

19. The storage device of claim 18, wherein the software stack includes a training application to specify preprocessing functions to offload to the storage device and store functions to store the data with a non-distributed layout.

20. The storage device of claim 12, wherein to preprocess the data includes performance one or more of:
image decoding;
image resizing;
execution of a random crop;
execution of a random horizontal flip;
normalization of an image to preconfigured image parameters; or,
image transposition.

21. A method for data access, comprising:
identifying data for iterative processing to train a machine learning model at a processor node;
generating a request for the data from an external storage device; and
sending the request to trigger a storage node of the external storage device to read the data, preprocess the data to perform data transformation on the data prior to returning the data to the processor node.

22. The method of claim 21, wherein generating the request comprises identifying a preprocessing operation to perform on the data by the storage node.
